(19) United States
(12) Patent Application Publication
(10) Pub. No.: US 2015/0037039 A1
(43) Pub. Date: Feb. 5, 2015

(54) VISIBLE LIGHT TRANSMISSION SYSTEM FOR VEHICLES

(71) Applicant: GENIE HOUSE CO., LTD., Hsinchu City (TW)

(72) Inventor: SU-CHEN CHANG, Hsinchu City (TW)

(73) Assignee: GENIE HOUSE CO., LTD., Hsinchu City (TW)

(21) Appl. No.: 14/083,711

(22) Filed: Nov. 19, 2013

(30) Foreign Application Priority Data
Jul. 30, 2013 (TW) 102127318

(51) Int. Cl. G08C 23/04

(52) U.S. Cl. CPC G08C 23/04
USPC 398/106

(57) ABSTRACT

A visible light communication system for vehicles, comprising a signal radiating device comprising a control unit, used for outputting a data signal; a coding unit, connected with the control unit for receiving the data signal, and coding the data signal into a transmission signal; a light emitting unit, connected with the coding unit and having at least one light emitting device for receiving the transmission signal and carrying the transmission signal onto a switch type light-source signal emitted from the at least one light emitting device; and a signal receiving device comprising a light receiving unit, used for receiving the switch type light-source signal carried with the transmission signal, and outputting the transmission signal; a decoding unit, connected with the light receiving unit, for receiving the transmission signal, and decoding the transmission signal into the data signal; and an application unit, used for receiving and identifying the data signal.

### CROSS-REFERENCE TO RELATED APPLICATION

This application claims the benefit of Taiwan Patent Application No. 102127318, filed on Jul. 30, 2013, which is hereby incorporated by reference for all purposes as if fully set forth herein.

### BACKGROUND

1. Field of the Invention

The present invention relates to a visible light transmission system for vehicles, and more particularly to a system in which a light-source signal carried with a vehicle related data and a vehicle condition data is emitted from the head light of a vehicle. The light-source signal can be received and the vehicle related data and the vehicle condition data thereof can be used for purposes of vehicle identification and other applications.

2. Related Art

The vehicle condition data controlled by a trip computer are usually displayed inside the vehicle. If a person wants to get the vehicle condition data from outside the vehicle, the person must enter into the vehicle or open the hood of the vehicle to check the vehicle condition data, and the vehicle condition data usually comprises: vehicle speed, braker status, vehicle idle time, vehicle driving time, vehicle driving mileage, tire pressure, engine temperature, vehicle radiator temperature, passenger number, and/or a seat belt status. In addition, it is more difficult to obtain the vehicle related data which may comprise vehicle security code, engine number, vehicle radiator model, pipeline model and custom codes. Moreover, some vehicle related data may not be seen even opening the hood of the vehicle, and a further disassembly may be required to obtain the vehicle related data, so that it is very time consuming for technicians during maintaining a vehicle.

Furthermore, checking the vehicle condition data is time-consuming and it may lower the efficiency of police officer and endanger the safety of police officer; for example, checking whether the passenger number meets the requirement of high-occupancy, whether the passenger fastens the seat belt during driving, whether the vehicle is a stolen vehicle by comparing the engine number. In addition, when maintaining a vehicle, a technician can't directly identify vehicle parts and model numbers from vehicle appearance, so that he/she must open the hood of the vehicle to have a confirmation, which will waste the time of the technician.

In a parking toll system, a driver must stop vehicle and take a parking ticket, and then enter parking lot. In addition, a driver also needs to use a remote control if he/she wants to park his/her car in a garage.

In current vehicle date identification, a microwave transmission is mainly used currently, e.g. ETC (electronic toll collection) system. ETC system is composed of equipments of a microwave technology, an electronic technology, a computer technology, a communication and internet technology, a information technology, a sensing technology and an image identification technology, and software etc., so that drivers can pass a toll without stopping vehicle.

Please refer to FIG. 1, it illustrates a block diagram according to prior art. ETC 1 identifies a special code of on-board Unit (OBU) 3 disposed on the vehicle via a signal transmission-reception system (RES) 2 disposed on road-sides. A computer 4 calculates a toll fee by determining the type of a vehicle, and then automatically debits the toll fee from a personal account of the vehicle; however, the drivers must slow down vehicle speed while the vehicle passing through the toll system for microwave sensing.

As the foregoing, if a person wants to obtain an information data of a vehicle, he/she must enter into the vehicle, so that the person can not immediately obtain the vehicle's related information data and a real-time communication can't be achieved. In addition, in the ETC system, because the information data is transmitted by a microwave sensor technology, the transmission speed may become slow when a large quantity of the information data is transmitted; moreover, ETC can only perform a limit transmission which doesn't include the related vehicle information data, and the system doesn't meet a protocol of vehicle data transmission, so that ETC can't work with the trip computer.

### SUMMARY

In order to solve the abovementioned problems, an objective of the present invention provides a visible light communication system for vehicles. In the system, a light-source signal carried with a vehicle related data and a vehicle condition data is emitted from a head light of a vehicle. The light-source signal can be received and the vehicle related data and the vehicle condition data thereof can be used for purposes of vehicle identification and other applications.

The visible light communication system for vehicles of the present invention comprises a signal radiating device and a signal receiving device, wherein the signal radiating device comprises a control unit, and the control unit is a trip computer. In addition, the protocol of the data transmission may include at least one of a FlexRay, a control area network (CAN) and a local interconnect network (LIN). The control unit outputs a data signal based on the transmission data, and the data signal is then received by a coding unit.

The data signal may include information including at least one of a vehicle security code, an engine number, and a custom code, and it may further include at least one of a vehicle speed, a braker status, a vehicle idle time, a vehicle driving time, a vehicle driving mileage, a tire pressure, an engine temperature, a vehicle radiator temperature, a passenger number and/or a seat belt status.

The coding unit codes the data signal into a transmission signal and outputs it to a light emitting unit. The light emitting unit is connected electrically with the coding unit and has at least one light emitting device, and the light emitting unit receives the transmission signal, makes the transmission signal to be carried onto a switch type light-source signal to be emitted from the at least one light emitting device, and emits the switch type light-source signal to a signal receiving device.

The light emitting device includes a light emitting diode with color and brightness adjustable.

The signal receiving end comprises a light receiving unit, used for receiving the switch type light-source signal carried with the transmission signal, and outputting the transmission signal; a decoding unit, connected electrically with the light receiving unit, for receiving the transmission signal and decoding the transmission signal into the data signal; and an application module, used for receiving and identifying the data signal and then performing a corresponding service according to an identified result, wherein the service includes an identification of the related vehicle data comprising a vehicle security code, an engine number, and/or a custom code for vehicle maintenance or stolen car check. Moreover, the service includes a determination of whether a vehicle speed, a braker status, an vehicle idle time, a vehicle driving time, a vehicle driving mileage, a tire pressure, an engine temperature, a vehicle radiator temperature, a passenger number, and/or a seat belt status meets a regulation value.

The application module includes software or hardware.

The signal receiving device is arranged in a main machine, and the main machine may belong to a system including at least one of a toll system, a security system, a high-occupancy vehicle system, an inspection and maintenance system, and an over-speed detection system.

As the foregoing, the present invention may apply to a toll system, a security system, a high-occupancy vehicle system, an inspection and maintenance system, so as to promote communication efficiency between the inside and the outside of the vehicle.

The present invention will be described as following in detail with reference to the accompanying drawings.

### BRIEF DESCRIPTION OF THE DRAWINGS

FIG. 1 illustrates a system block diagram according to prior art.

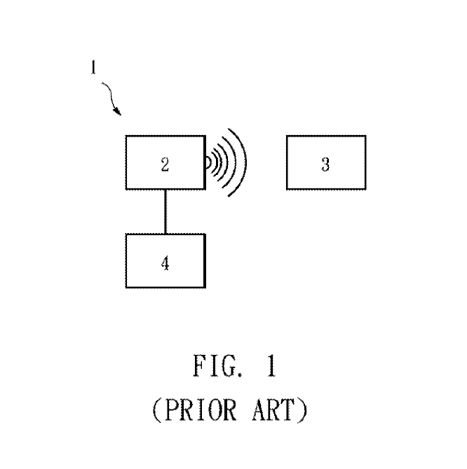

FIG. 2 illustrates a block diagram of a visible light communication system for vehicles according to an embodiment of the present invention.

FIG. 3 illustrates a system block diagram of a visible light communication system for vehicles according to an embodiment of the present invention.

FIG. 4 illustrates a diagram of an application of visible light communication system for vehicles according to an embodiment of the present invention.

### DETAILED DESCRIPTION

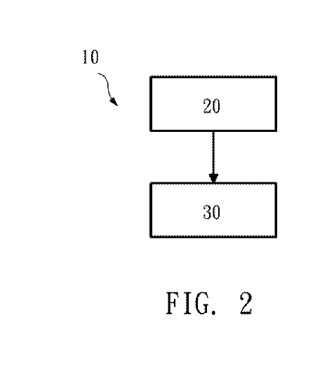

Please refer to FIG. 2, it illustrates a block diagram of a visible light communication system for vehicles according to an embodiment of the present invention. The present invention provides a visible light communication system 10 comprising a signal radiating device 20 and a signal receiving device 30.

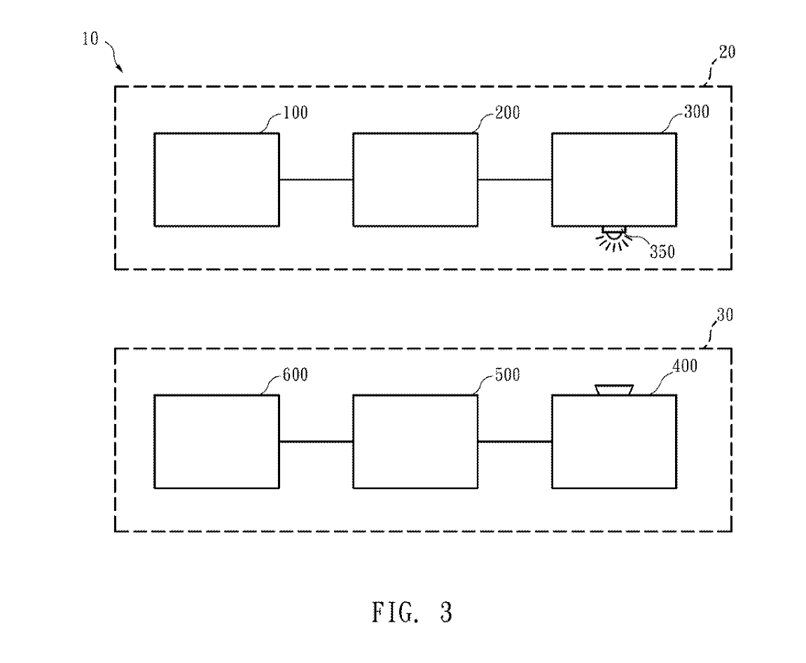

Please refer to FIG. 3, it illustrates a system block diagram of a visible light communication system for vehicles according to an embodiment of the present invention. The signal radiating device 20 comprises a control unit 100, a coding unit 200, and a light emitting unit 300. The signal receiving device 30 comprises a light receiving unit 400, a decoding unit 500, and an application module 600. The signal radiating device 20 transmits the required data to the signal receiving unit 30 via light.

The control unit 100 is a trip computer for outputting a data signal to the coding unit 200, and the data signal can be selectively transmitted to outside of the vehicle according to required information, wherein the data signal contains the vehicle related data including at least one of a vehicle security code, an engine number and a custom code, or the vehicle part model data including a vehicle radiator model number and a pipe model number and so on, and the data signal may further including the vehicle condition data including at least one of a vehicle speed, a braker status, a vehicle idle time, a vehicle driving time, a driving mileage, a tire pressure, an engine temperature, a vehicle radiator temperature, and a seat belt status.

The protocol of the vehicle data transmission of the control unit 100 includes at one of a FlexRay, a control area network (CAN) and a local interconnect network (LIN).

The control unit 100 is a programmable IC.

The data signal may further comprise a predetermined data set by a user including a garage password, a vehicle plate number.

The code unit 200 is connected electrically with the control unit 100 for receiving the data signal, coding the data signal output by the control unit 100 into a transmission signal, and outputting the transmission signal to the light emitting unit 300.

The light emitting unit 300 is connected electrically with the coding unit 200 and has at least one light emitting device 350.

The light emitting unit 300 is used for receiving the transmission signal output by the coding unit 200 and making the transmission signal to be carried onto a switch type light-source signal to be emitted from the at least one light emitting device 350 to the light receiving unit 400.

The light emitting device 350 is a light emitting diode, and is also a lighting device of the vehicle, which provides the functions of an illumination and a data transmission, simultaneously. Moreover, the color and brightness of the light emitting device 350 are adjustable, for example, the brightness of the light emitting device 350 is lower under a cloudy day, or the brightness of the light emitting device 350 must be higher under a rainy day or a foggy day.

The light-source frequency of the light radiated by the light emitting unit 300 is adjustable so as to prevent from interfering by other light during transmission of light-signal, which leads to a transmission error.

The light receiving unit 400 comprises a light sensing device for receiving the switch type light-source signal carried with the transmission signal radiated by the light emitting unit 300, and outputting the transmission signal to the decoding unit 500.

The decoding unit 500 is connected electrically with the light receiving unit 400 for receiving the transmission signal and decoding the transmission signal into the data signal, and then outputting to the application module 600.

The application module 600 is used for receiving and identifying the data signal and then performing a corresponding service according to the identified result, wherein the service includes an identification of the related vehicle data comprising a vehicle security code, an engine number, and/or a custom code for vehicle maintenance or stolen car check. For example, the vehicle security code may be transmitted to the application module 600 for an identification of whether the password is correct so as to perform a service such as open or close the garage door. Furthermore, a custom code or an engine number may be transmitted to the application module 600 for a mechanic or a police officer to conveniently identify vehicle part model number, so that the mechanic can fast determine part model to increase his/her work efficiency and the police officer can fast determine whether the vehicle is a stolen car.

The application module 600 is software or hardware.

The service may further include a determination of whether a vehicle speed, a braker status, a vehicle idle time, a vehicle driving time, a driving mileage, a tire pressure, an engine temperature, a vehicle radiator temperature, and/or a seat belt status meets a regulation value. For example, a determine of the braker status, the vehicle idle time, the vehicle driving time, the driving mileage, the tire pressure, the engine temperature, and the vehicle radiator temperature can ensure a driving safety, and let a mechanic fast understand the vehicle status. Moreover, the police officer can conveniently make a determination through whether the vehicle speed and the use status of seat belt meets a regulation value, wherein the regulation value may be, for example, a passage number of the high occupancy vehicle, a number of buckled seat belt, or a speeding limit value to prevent from violating a traffic regulation.

The signal receiving device 30 is arranged in a main machine, and the main machine may belong to a system including at least one of a toll system, a security system, a high-occupancy vehicle system, an inspection and maintenance system, and an over-speed detection system. For example, when the signal receiving device 30 is arranged in the toll system, a driver doesn't need to stop a vehicle to take a ticket and can directly pass through a toll by radiating a signal from a headlight of the vehicle; when the signal receiving device 30 is arranged in the security system, a light-source signal of garage password can be radiated from a headlight of the vehicle; when the signal receiving device 30 is arranged in the high-occupancy vehicle system, a light-source signal of buckled seat belt can be emitted from a headlight of the vehicle to show passenger number in the vehicle so as to prevent the driver from violating a traffic regulation and improve the work efficiency of police officer; when the signal receiving device 30 is arranged in the inspection and maintenance system, the vehicle related data such as custom code or engine number and the vehicle condition data such as vehicle speed, brake status, idle time, vehicle driving time, vehicle driving mileage, tire pressure, engine temperature, and vehicle radiator temperature can be known by a light-source signal radiated emitted from a headlight of the vehicle, so that the work efficiency of mechanic; when the signal receiving device 30 is arranged in the over-speed detection system, the speed of the vehicle is known by a light-source signal radiated emitted from a headlight of the vehicle so as to prevent the vehicle from violating a traffic regulation.

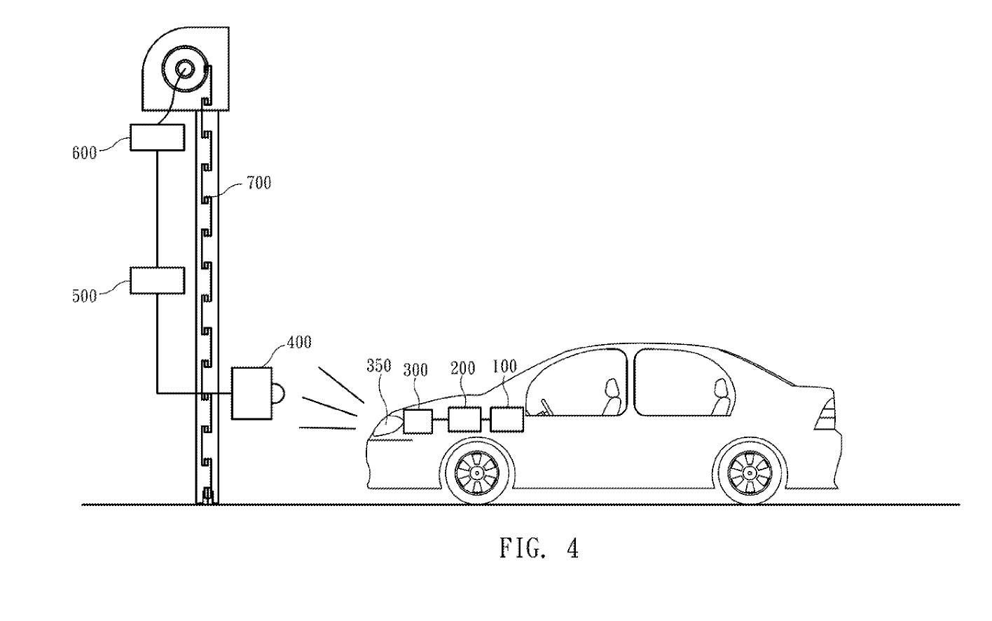

Please refer to FIG. 4, it illustrates a diagram of an application of visible light communication system for vehicles according to an embodiment of the present invention. When the signal receiving device 30 is arranged in the garage, the control unit 100 outputs the data signal to the coding unit 200, wherein the data signal contains the information of the garage password. And then the coding unit 200 receives the data signal.

The data signal coded into a transmission signal is output by the coding unit 200 to the light emitting unit 300, wherein the light emitting unit 300 has at least one light emitting device 350, and the light emitting device 350 may be a headlight of a vehicle. The light emitting unit 300 is used for receiving the transmission signal, making the transmission signal to be carried onto the light-source signal emitted by the light emitting device 350 and outputting the light-source signal carried with the transmission signal to the signal receiving device 30.

The signal receiving device 30 includes the light receiving unit 400 for receiving the light-source signal carried with the transmission signal and outputting the transmission signal to the decoding unit 500. The decoding unit 500 is used for receiving the transmission signal and outputting the transmission signal decoded into the data signal to the application module 600. When receiving the data signal, the application module 600 determines whether the garage password is correct so as to open the garage door 700 or not.

The previous description of the preferred embodiment is provided to further describe the present invention, not intended to limit the present invention. Any modification apparent to those skilled in the art according to the disclosure within the scope will be construed as being included in the present invention.

What is claimed is:

1. A visible light communication system for vehicles, comprising:
a signal radiating device comprising:
a control unit, used for outputting a data signal;
a coding unit, connected electrically with the control unit for receiving the data signal, and coding the data signal into a transmission signal;
a light emitting unit, connected electrically with the coding unit and having at least one light emitting device for receiving the transmission signal and carrying the transmission signal onto a switch type light-source signal emitted from the at least one light emitting device; and
a signal receiving device comprising:
a light receiving unit, used for receiving the switch type light-source signal carried with the transmission signal, and outputting the transmission signal;
a decoding unit, connected electrically with the light receiving unit, for receiving the transmission signal, and decoding the transmission signal into the data signal; and
an application unit, used for receiving and identifying the data signal and then performing a corresponding service according to an identified result.

2. The visible light communication system for vehicles of claim 1, wherein a protocol of the data transmission of the control unit includes at one of a FlexRay, a control area network (CAN) and a local interconnect network (LIN).

3. The visible light communication system for vehicles of claim 1, wherein the control unit is a trip computer.

4. The visible light communication system for vehicles of claim 1, wherein the data signal contains information including at least one of a vehicle security code, an engine number, and a custom code.

5. The visible light communication system for vehicles of claim 1, wherein the data signal contains information including at least one of a vehicle speed, a braker status, a vehicle idle time, a vehicle driving time, a driving mileage, a tire pressure, an engine temperature, a vehicle radiator temperature, a passenger number, and a seat belt status.

6. The visible light communication system for vehicles of claim 1, wherein the light emitting device includes a light emitting diode with color and brightness adjustable.

7. The visible light communication system for vehicles of claim 1, wherein the application module includes software or hardware.

8. The visible light communication system for vehicles of claim 1, wherein the service includes an identification of a vehicle security code, an engine number, or a custom code.

9. The visible light communication system for vehicles of claim 1, wherein the service includes a determination of whether a vehicle speed, a braker status, an vehicle idle time, a vehicle driving time, a driving mileage, a tire pressure, an engine temperature, a vehicle radiator temperature, a passenger number, or a seat belt status meets a regulation value.

10. The visible light communication system for vehicles of claim 1, wherein the signal receiving device is arranged in a main machine, and the main machine belongs to a system including at least one of a toll system, a security system, a high-occupancy vehicle system, an inspection and maintenance system, and an over-speed detection system.
